(19) United States
(12) Patent Application Publication
(10) Pub. No.: US 2025/0378768 A1
(43) Pub. Date: Dec. 11, 2025

(54) MODEL EYE FOR EVALUATING A RETINAL IMAGING SYSTEM

(71) Applicant: Verily Life Sciences LLC, Dallas, TX (US)

(72) Inventors: Bo Lu, Santa Clara, CA (US); Sam Kavusi, Menlo Park, CA (US); Dar Bahatt, Foster City, CA (US)

(21) Appl. No.: 19/199,995

(22) Filed: May 6, 2025

Related U.S. Application Data
(60) Provisional application No. 63/658,151, filed on Jun. 10, 2024.

(51) Int. Cl. G09B 23/30

(52) U.S. Cl. CPC G09B 23/30

(57) ABSTRACT

A model eye for evaluating a retinal imaging system includes a retinal cup and a resolution target. The retinal cup includes an interior surface having a bowl-like shape to represent a fundus of a human eye. The resolution target is disposed on the interior surface for assessing a spatial resolution of the retinal imaging system. The resolution target includes light and dark contrasting regions with straight edges separating the light and dark contrasting regions. At least two of the straight edges are orthogonal. An array of dark color microfeatures may be disposed in the light contrasting region and an array of light color microfeatures may be disposed in the dark contrasting region. The light and dark color microfeatures are variably sized for assessing the spatial resolution of the retinal imaging system.

### CROSS-REFERENCE TO RELATED APPLICATION

This application claims priority to U.S. Provisional Application No. 63/658,151, filed on Jun. 10, 2024, the contents of which are incorporated herein by reference.

### TECHNICAL FIELD

This disclosure relates generally to model eyes, and in particular but not exclusively, relates to model eyes for evaluating a retinal imaging systems.

### BACKGROUND INFORMATION

A model eye with features disposed on the fundus can be a valuable standalone product for the characterization and calibration of fundus cameras. Use cases for a model eye include obtaining actionable feedback during the design of a fundus camera, validating the correct manufacture and assembly of a fundus camera, training the end user of the fundus camera, troubleshooting a fundus camera, calibrating a fundus camera, etc.

One problem associated with widefield (WF) and ultra widefield (UWF) fundus cameras is the distortion and magnification in the peripheral field. This is an inherent issue of projecting a curved area (i.e., the retina) onto a flat surface (two-dimensional image of the retina). The most peripheral areas of the posterior pole result in greater magnification while the horizontal axis is stretched compared with the vertical axis. Recent advances in UWF imaging use stereographic projection software to help in correction of peripheral distortion. A model eye can be used to evaluate the precision of optics, as well as, validate the performance of the stereographic projection software.

Few model eyes are commercially available for characterization and calibration of a fundus camera, and those that are available have a number of limitations. While existing model eyes may have accurate geometries and optical properties, they do not include sufficient features to accurately test many benchmarks of the model retina. For example, some conventional model eyes simply include a large painted pattern on the retina, which is not particularly useful for camera characterization and calibration. Other conventional model eyes include a photorealistic fundus, but such a fundus is not well suited for quantitative measurements of a camera's components. Yet other conventional model eyes include very limited features for camera characterization and generally are only designed to represent an emmetropic eye. A model eye with a robust set of features for characterizing and calibrating diverse metrics and sub-systems of a fundus camera system is desirable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is an exploded perspective view illustration of a model eye including a retinal cup adapted to evaluate a fundus camera, in accordance with an embodiment of the disclosure.

FIG. 2A is a plan view illustration of the interior surface of the retinal cup including resolution targets and field of view (FOV) rings disposed thereon, in accordance with an embodiment of the disclosure.

FIG. 2B illustrates a resolution target including arrays of dark and light color microfeatures for assessing the spatial resolution of the fundus camera, in accordance with an embodiment of the disclosure.

FIG. 2C illustrates plan and cross-sectional view illustrations of a resolution target having a colored light contrasting region, in accordance with an embodiment of the disclosure.

FIG. 2D illustrates a plurality of resolution targets having multiple different colors distributed about the interior surface of the retinal cup, in accordance with an embodiment of the disclosure.

FIG. 2E is a plan view illustration of a retinal cup including an array of color dots distributed across the interior surface for color calibration, in accordance with an embodiment of the disclosure.

FIG. 3A is a perspective view illustrating of the retinal cup having recesses formed into the interior surface to aid positioning of the resolution targets on the interior surface along with platform regions having different offset heights for assessing depth of field (DOF), in accordance with an embodiment of the disclosure.

FIG. 3B is a plan view illustration showing the platform regions segmented into pie-shaped quadrants, in accordance with an embodiment of the disclosure.

FIG. 4A illustrates deformation shape transformations, in accordance with an embodiment of the disclosure.

FIG. 4B illustrates translational shift transformations, in accordance with an embodiment of the disclosure.

FIG. 5A illustrates a myopic retinal cup having a shape achieved using a deformation shape transformation, in accordance with an embodiment of the disclosure.

FIG. 5B illustrates a hyperopic retinal cup having a shape achieved using a translational shift transformation, in accordance with an embodiment of the disclosure.

### DETAILED DESCRIPTION

Embodiments of a system, apparatus, and method of use of a model eye for evaluating a retinal imaging systemare described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the model eye described herein include features and subcomponents adapted to evaluate a number of attributes/characteristics of a fundus camera or other retinal imaging system. The various features described below enable evaluation of the following fundus camera characteristics: (1) spatial resolution (e.g., via calculation of modulation transfer function or MTF), (2) field of view (FOV), (3) color calibration, (4) depth of field (DOF), and (5) autofocus functionality. The various features of the model eye that support and facilitate the evaluation of each of the above listed fundus camera characteristics are described in detail below.

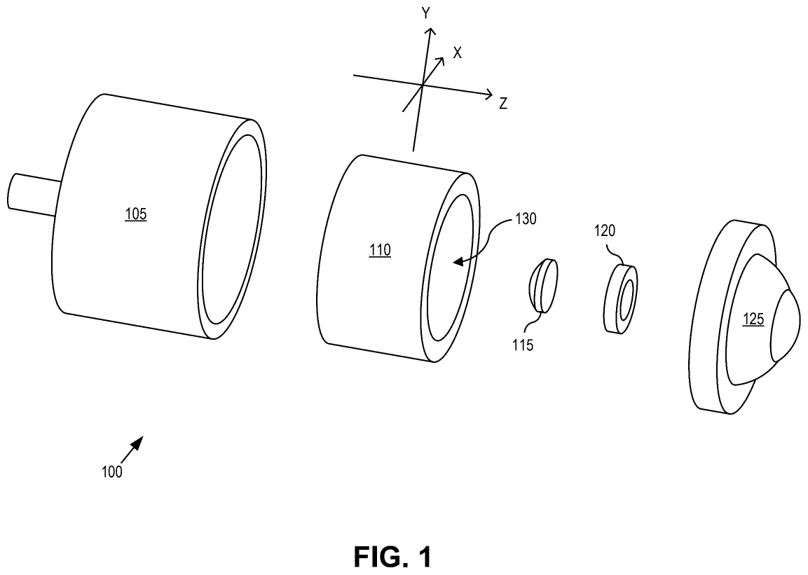

FIG. 1 is an exploded perspective view illustration of a model eye 100 adapted to evaluate various characteristics of a fundus camera, in accordance with an embodiment of the disclosure. The illustrated embodiment of model eye 100 includes an outer holder 105, a retinal cup 110, a crystalline lens 115, an iris insert 120, and a corneal plate 125. When assembled, retinal cup 110 slides into outer holder 105 while corneal plate 125 clamps over the top of retinal cup 110 and is held in place by outer holder 105. Crystalline lens 115 attaches to iris insert 120 while the combined iris insert 120 and crystalline lens 115 attach to the inside of corneal plate 125. Retinal cup 110 defines an interior cavity 130 including an interior surface having a bowl-like shape (e.g., concave) that represents a fundus of a human eye. When corneal plate 125 is clamped to retinal cup 110, interior cavity 130 is sealed and defined by retinal cup 110 and corneal plate 125. The interior cavity 130 may be sealed with an o-ring positioned between retinal cup 110 and corneal plate 125 and operate as a fluid chamber when filled with a liquid (e.g., distilled water, saline solution, etc.) to represent the vitreous humor of the human eye. In the various embodiments described below, various features/components may be attached to, machined into, or otherwise disposed on the interior surface of retinal cup 110 to facilitate the evaluation of a fundus camera.

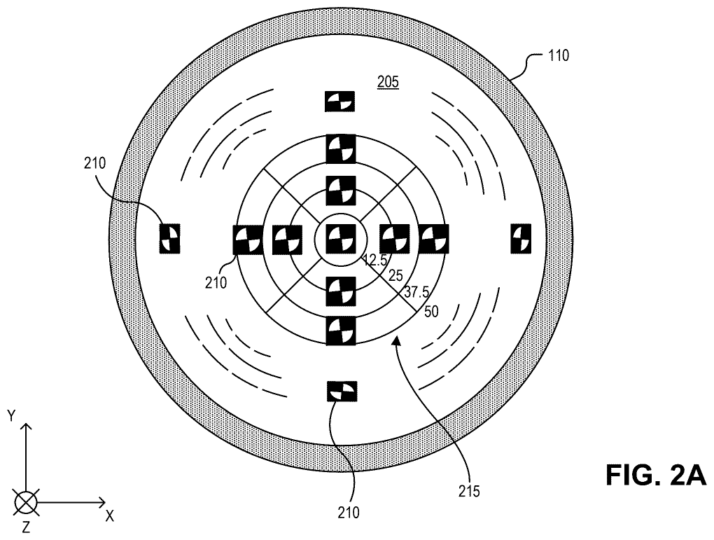

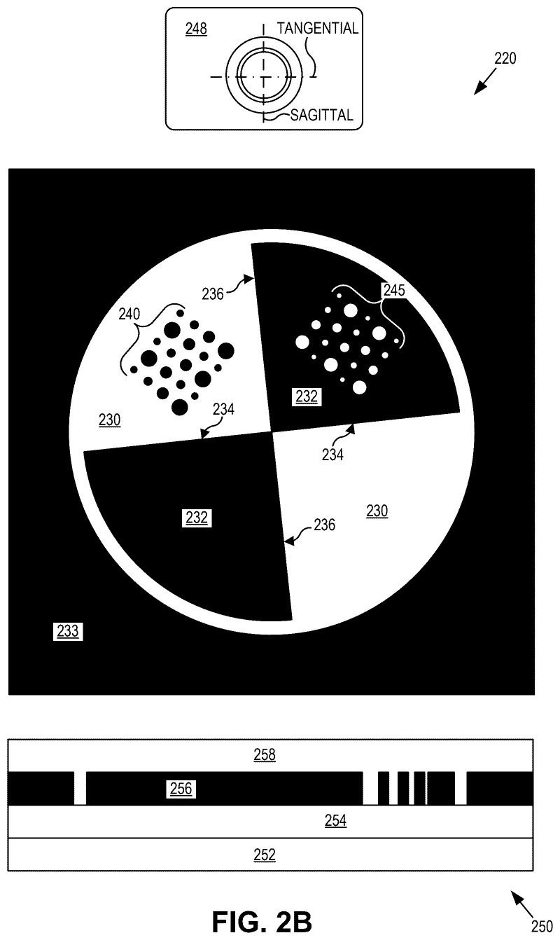

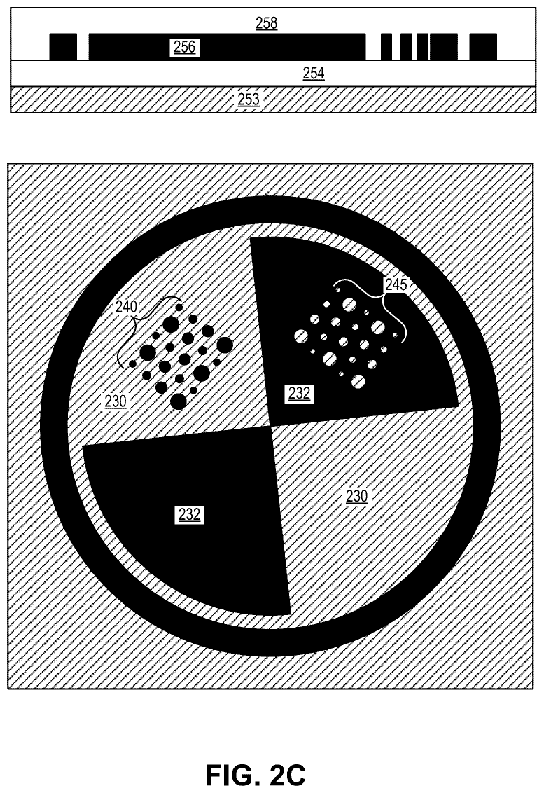

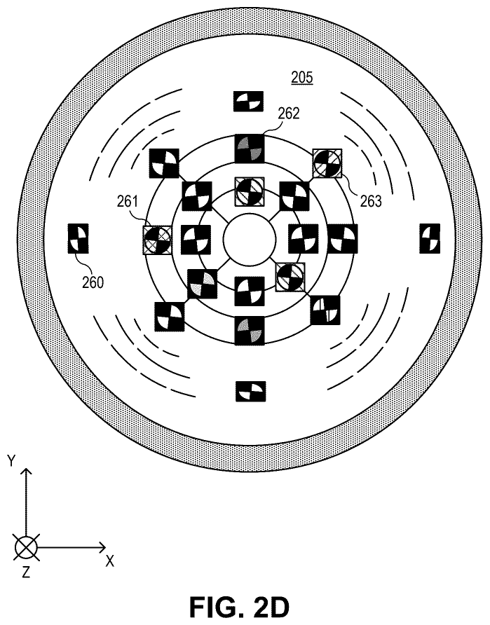

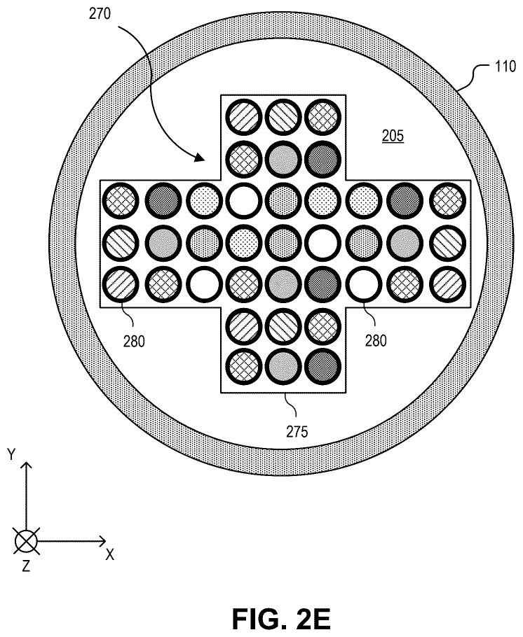

FIG. 2A is a plan view illustration of a first example interior surface 205 of retinal cup 110 including features for evaluating spatial resolution and FOV of a fundus camera, in accordance with an embodiment of the disclosure. The illustrated embodiment of interior surface 205 includes resolution targets 210 (only some of which are labeled) and field of view (FOV) rings 215 disposed thereon.

In the illustrated embodiment, resolution targets 210 are disposed on and about interior surface 205 at different angular and radial locations amongst FOV rings 215. Resolution targets 210 include light and dark contrasting regions with straight edges separating the light and dark contrasting regions. Model eye 100 may be positioned relative to a fundus camera for imaging of interior surface 205 through crystalline lens 115 and corneal plate 125. The captured image(s) may then be analyzed to characterize the performance of the fundus camera. One such analysis is a measurement of the MTF on the slanted edges of resolution targets 210. Measurement of the MTF on these straight/slanted edges provides a spatial resolution measurement at the various locations (angular and radial positions) of each resolution target 210. In one embodiment, each resolution target 210 is approximately 2.5 mm×2.5 mm, though other sizes may be used. The small size of each resolution target 210 allows them to adhere to the concave curvature of interior surface 205.

Since interior cavity 130 is filled with a fluid to simulate a vitreous humor, in some embodiments, resolution targets 210 and interior surface 205 are coated with an encapsulate film to seal the resolution targets 210 from the fluid and prevent delamination or degradation of the resolution targets from interior surface 205. In one embodiment, the encapsulate film is a 5 um thick parylene film applied using chemical vapor deposition. Of course, other optically transparent encapsulation films and application processes may be used.

The FOV of the fundus camera may be evaluated using the concentric circles of FOV rings 215. Each concentric circle corresponds to a different FOV (e.g., 12.5 degrees, 25 degrees, 37.5 degrees, 50 degrees, etc.). The position of each concentric circle may be determined using optical simulation software (e.g., Zemax) to convert the three-dimensional (3D) FOV to a projected 2D distance. After determining the projected 2D diameter of each circle, various manufacturing techniques may be used to introduce FOV rings 215 on interior surface 205. In one embodiment, FOV rings 215 are scribed onto the concave interior surface 205 using a low-power UV laser. Since each circle is at a different height due to the curvature of interior surface 205, focus of the scribing laser is adjusted during this process to allow an accurate 3D laser micromachining. In other embodiments, FOV rings 215 may be printed, silk screened, drawn, micromachined, or otherwise disposed on interior surface 205.

FIG. 2B illustrates a resolution target 220, in accordance with an embodiment of the disclosure. Resolution target 220 represents one possible implementation of resolution targets 210. The illustrated embodiment of resolution target 220 includes a light contrasting region 230 and a dark contrasting region 232 separated by straight edges 234 and 236 along with an array of dark color microfeatures 240 and an array of light color microfeatures 245.

In the illustrated embodiment, straight edges 234 and 236 are orthogonal to each other for measuring horizontal and vertical spatial resolution. Resolution target 220 may be referred to as a spatial frequency response registration (SFRreg) marker. It is noteworthy that the SFRreg is rotated such that straight edges 234 and 236 are oblique to tangential and sagittal planes of the optics of fundus camera 248 when model eye 100 is positioned relative to fundus camera 248 similar to how a human eye would be positioned when imaging the human eye. The MTF can be measured using a relatively small rotation angle (e.g., 5 degrees) such that straight edges 234 and 236 have relatively modest slants relative to the tangential and sagittal planes. It should be appreciated that other resolution targets 210 may be implemented using other target patterns than just a SFRreg marker. Although much of this disclosure discusses evaluation of a fundus camera using model eye 100, it should be understood that model eye 100 and the disclosed embodiments of the retinal cup are equally applicable to evaluation other types of retinal imaging systems including optical coherence tomography (OCT) imaging systems, adaptive optics, scanning laser ophthalmoscopes, etc.

The array of dark color microfeatures 240 is disposed in light contrasting region 230 while the array of light color microfeatures 245 is disposed in dark contrasting region 232. The microfeatures of each array are variably sized for easily assessing the spatial resolution of fundus camera 248. The microfeatures may range in sizes that correspond to typical microaneurysms or drusens found in a diseased human eye. For example, the microfeatures may include 15 μm, 20 μm, 25 μm, and 30 μm feature sizes (e.g., diameters). By including the arrays 240 and 245, a quick glance of a picture acquired by fundus camera 248 can visually confirm whether fundus camera 248 is able to identify microaneurysms or drusens, and if so, what sizes of microaneurysms or drusens are identifiable by fundus camera 248. In the illustrated embodiment, microfeatures are organized into a microfeature pattern that positions a largest microfeature immediately adjacent to a smallest microfeature. This pattern helps to quickly spot the smallest microfeature since the viewer knows that the smallest microfeatures is positioned adjacent and/or between the largest most easily identified microfeatures. Again, this position facilitates quick visual identification/characterization of the capabilities of fundus camera 248 without need of software analysis of the fundus image.

FIG. 2B further includes a cross-sectional illustration 250 of one possible implementation of resolution target 220. In one embodiment, resolution target 220 is formed using an emulsion pattern 256 disposed on a transparent flexible substrate 254 that is laminated with an adhesive backing 252. The adhesive backing 252 is used to adhere resolution target 220 to interior surface 205 of retinal cup 110. Emulsion pattern 256 forms the dark region 232 and peripheral area 233 of resolution target 220. Emulsion pattern 256 may then be overcoated with an encapsulate film 258 to protect emulsion pattern 256 and prevent delamination of adhesive backing 252. In one embodiment, transparent flexible substrate 254 is a 175 μm thick transparent Mylar substrate upon which a 5 μm thick emulsion layer is disposed. The emulsion layer may be developed into emulsion pattern 256 via laser exposure lithography followed by chemical bath developing to remove unwanted portions of the emulsion layer. The emulsion layer is a suitable material selection due to its water resistance to the liquid filled into interior cavity 130. Emulsion pattern 256 may be lithographically patterned to form the dark color microfeatures 240 as dots of emulsion while the light color microfeatures 245 are holes in the emulsion. Alternatively, microfeatures 240 or 245 can be made of metal (e.g., Cr, Au, etc.), patterned by lithography, and wet etched. Metal patterns are typically done of a thin-film parylene substrate (e.g., 10 to 20 μm thick).

Adhesive backing 252 may be implemented using a vinyl adhesive, which also provides good resistance to water intrusion. Referring to FIG. 2C, the clear adhesive backing 252 illustrated in FIG. 2B may be replaced with a colored adhesive backing 253, which is masked by emulsion pattern 256. Vinyl adhesives may be obtained in a variety of colors. In one embodiment, the colored vinyl adhesive layer is a shade of a color present on the fundus of a human eye. For example, colored adhesive backing 253 may be a shade of red, brown, or yellow. Of course, other colors may also be used. As illustrated in FIG. 2D, a multitude of different colored resolution targets 260, 261, 262, 263, etc. may be simultaneously attached to interior surface 205 in various locations. These multi-colored resolution targets help evaluate fundus camera spatial resolution across different contrasting colors. In one embodiment, dark contrasting region 232 remains black while light contrasting region 230 may assume different colors from colored adhesive backing 253. This also enables the array of light color microfeatures 245 to assume different colors that are relevant to real world colors present in the human eye to validate that fundus camera 248 is able to spot the microfeatures across different color combinations.

FIG. 2E is a plan view illustration of a retinal cup 110 including an array 270 of color dots distributed across interior surface 205 for color calibration, in accordance with an embodiment of the disclosure. The color dots of array 270 include a multitude of different colors that are pre-characterized colors for testing color fidelity of fundus camera 248. For example, the different colors may have associated color codes in RGB coordinates of the Macbeth chart or predefined values in CIELAB color space, where CIE refers to the “International Commission on Illumination” and LAB refers to L*a*b* which expresses color as three values: L* for perceptual lightness and a* and b* for the four unique colors of human vision: red, green, blue, and yellow. Of course, the color dots may be specified using other color spaces.

In the illustrated embodiment, array 270 is disposed on a carrier substrate 275 and each colored dot is backed by a light absorbing region 280. In the illustrated embodiment, carrier substrate 275 assumes a plus-sign shape to facilitate conformance to the concave shape of interior surface 205; however, carrier substrate 275 may assume other shapes as well (e.g., a cross, a square with corner cutouts, etc.). Although carrier substrate 275 is illustrated as a single substrate, it may be separated into multiple distinct carrier substrates to facilitate conformance to the concavity of interior surface 205.

Carrier substrate 275 provides a convenient group carrier of array 270 for easy assembly (e.g., pick and placement onto interior surface 205) while including an adhesive backing to adhere to interior surface 205. Each colored dot itself may be fabricated from a different piece of a colored vinyl adhesive. Light absorbing regions 280 extend out past each colored dot and are disposed behind each colored dot to reduce glare in the vicinity of each colored dot thereby improving color measurement. By comparing the reproduced colors of each colored dot in array 270 from images captured by fundus camera 248, the color tuning and image processing pipeline of fundus camera 248 can be evaluated. In one embodiment, the specific vinyl colors are selected to represent colors present on the fundus of a human eye (e.g., different shades of red, brown, yellow, etc.). Of course, the different colors of array 270 may be incorporated into resolution targets as illustrated in FIG. 2D.

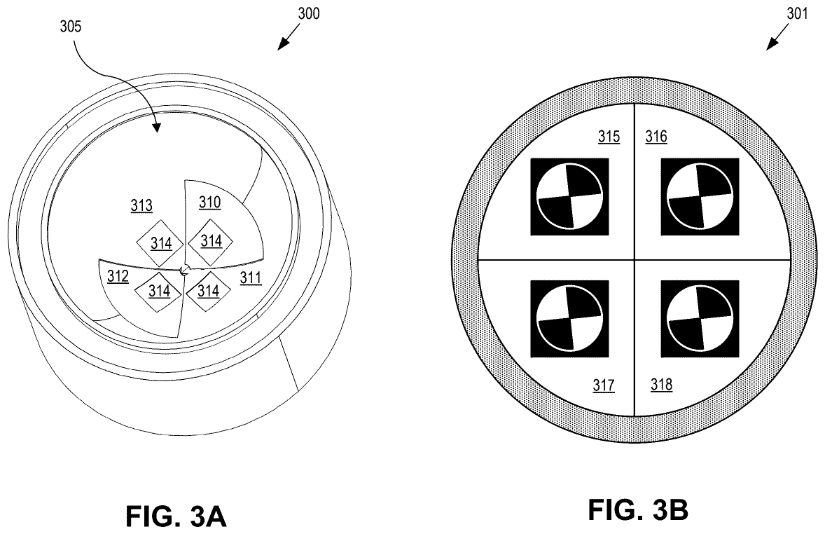

FIGS. 3A and 3B illustrate retinal cups 300 and 301 having interior surfaces formed to facilitate DOF measurements, in accordance with an embodiment of the disclosure. FIG. 3A illustrates a perspective view illustration of retinal cup 300 where interior surface 305 includes platform regions 310-313 having different offset heights. In the illustrated embodiment, each platform region 310-313 includes at least one recess 314 formed into interior surface 305. Recesses 314 are shallow depressions sized and shaped to accept an associated resolution target. Recesses 314 aid in the proper positioning of resolution targets on interior surface 305. Of course, recesses 314 may be included in any of the embodiments described herein just as it is anticipated that the features of the various embodiments disclosed herein may be mixed and matched together in various embodiments not explicitly illustrated.

FIG. 3B is a plan view illustration of a similar retinal cup 301 where the interior surface includes platform regions 315-318 segmented into pie-shaped quadrants within the bowl-like shape of the interior surface. Each platform region 315-318 is disposed at a different offset height. The DOF can be assessed in at least two different ways. In the first approach, any of the retinal cups described herein that include a resolution target can be used. By changing the focus motor step of fundus camera 248 between successive fundus images, a series of images are acquired. The MTF can be calculated from a given resolution target and plotted as a function of defocus. The DOF can then be calculated as the full width half maximum (FWHM) of the normalized MTF vs defocus plot.

In a second approach for assessing DOF, either of retinal cup 300 or 301 is used. A single image of the multiple different resolution target at different offset heights is captured and the MTF for each offset resolution target is determined. These MTFs may then be plotted as a function offset height, which in turn corresponds to different amounts of defocus. Again, the MTFs may be plotted versus defocus and the DOF measured as the FWHM of the normalized MTF vs defocus plot.

Offset platform regions 310-313 or 315-318 may also be used to test the autofocus of fundus camera 248. To assess if the autofocus of fundus camera 248 is accurate and functioning properly, a focus sweep test may be performed. During the focus sweep test, the focus settings of fundus camera 248 are manually swept through different diopter settings (e.g., ±5D, ±10D, ±15D, ±20D, etc.). Each of offset platform regions 310-313 or 315-318 may be designed to have an offset height calibrated to bring the resolution target disposed thereon into focus for a different diopter setting. Accordingly, as fundus camera 248 sweeps through the diopter settings, different resolution targets should come into focus at different focus settings enabling a validation of the autofocus feature.

Additionally, multiple retinal cups 110 may be designed where interior surface 205 is designed to replicate emmetropic, myopic, or hyperopic eyes. Each of these emmetropic, myopic, or hyperopic retinal cups may then further include platform regions 310-313 or 315-318 machined into the concave interior surface. In this manner, the autofocus and DOF of fundus camera 248 may be measured, calibrated, or otherwise evaluated across emmetropic, myopic, and hyperopic model eyes.

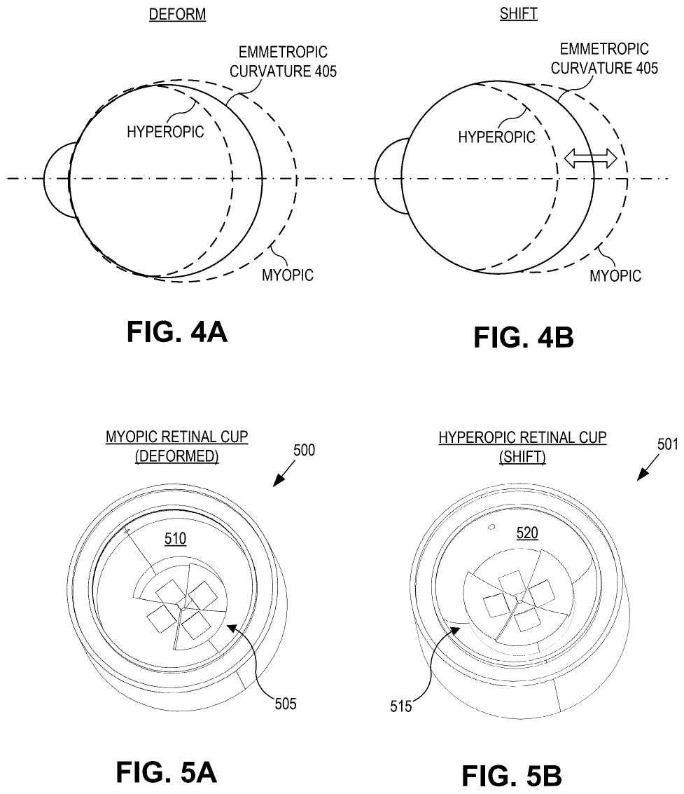

FIGS. 4A, 4B, 5A, and 5B illustrate the design of myopic and hyperopic model eyes. There are two geometric transformations that may be applied to simulate hyperopic or myopic diseased eyes. FIG. 4A illustrates a deformation transformation where emmetropic curvature 405 is “deformed” towards the cornea to simulate a hyperopic eye and deformed away from cornea to simulate a myopic eye. The deformation transformation changes the curvature from an emmetropic shape associated with an emmetropic eye to a compressed elliptical shape (hyperopic) or stretched elliptical shape (myopic). Correspondingly, FIG. 4B illustrates a translational shift transformation that doesn't change the shape of emmetropic curvature 405, but rather just translates or shifts emmetropic curvature 405 towards the cornea (hyperopic) or away from the cornea (myopic). It is believed that the deformation transformation is more suitable for simulating a myopic fundus (myopic retinal cup 500 illustrated in FIG. 5A) as the shift transformation underestimates the severity of myopia. Correspondingly, the translational shift is believed to be more suitable for simulating a hyperopic fundus (hyperopic retinal cup 501 illustrated in FIG. 5B). In the illustrated embodiment of FIG. 5A, myopic retinal cup 500 includes platform regions 505 of different offset heights corresponding to different diopter settings recessed into the interior surface 510 of myopic retinal cup 500. Accordingly, myopic retinal cup 500 enables realistic evaluation of the DOF and autofocus of fundus camera 248 on a model myopic eye. In the illustrated embodiment of FIG. 5B, hyperopic retinal cup 501 includes platform regions 515 of different offset heights corresponding to different diopter settings protruding from the interior surface 520 of hyperopic retinal cup 501. Hyperopic retinal cup 501 enables realistic evaluation of the DOF and autofocus of fundus camera 248 on a model hyperopic eye.

The testing processes explained above may be described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A model eye for evaluating a retinal imaging system, the model eye comprising:
a retinal cup including an interior surface having a bowl-like shape to represent a fundus of a human eye;
a resolution target disposed on the interior surface for assessing a spatial resolution of the retinal imaging system, the resolution target including light and dark contrasting regions with straight edges separating the light and dark contrasting regions, wherein at least two of the straight edges are orthogonal;
an array of dark color microfeatures disposed in the light contrasting region, wherein the dark color microfeatures are variably sized for assessing the spatial resolution of the retinal imaging system; and
an array of light color microfeatures disposed in the dark contrasting region, wherein the light color microfeatures are variably sized for assessing the spatial resolution of the retinal imaging system.

2. The model eye of claim 1, wherein the resolution target comprises an emulsion pattern disposed on a transparent flexible substrate and laminated with an adhesive backing that adheres the transparent flexible substrate to the interior surface of retinal cup, wherein the emulsion pattern forms the dark contrasting region.

3. The model eye of claim 2, wherein the dark color microfeatures comprise dots in the emulsion pattern and the light color microfeatures comprise holes in the emulsion pattern.

4. The model eye of claim 2, wherein the adhesive backing comprises a colored vinyl adhesive layer that is masked by the emulsion pattern, wherein a color of the colored vinyl adhesive layer includes a shade of a color present on the fundus of the human eye.

5. The model eye of claim 1, wherein the arrays of the light and dark color microfeatures are each organized into a microfeature pattern that positions a largest microfeature immediately adjacent to a smallest microfeature.

6. The model eye of claim 1, wherein the arrays of light and dark color microfeatures have a range of sizes that correspond to microaneurysms or drusens.

7. The model eye of claim 1, further comprising:
field of view (FOV) rings etched into the interior surface of the retinal cup for assessing a FOV of the retinal imaging system; and
a plurality of resolution targets, including the resolution target, disposed at different angular and radial locations on the interior surface amongst the FOV rings.

8. The model eye of claim 7, further comprising:
recesses formed into the interior surface of the retinal cup, the recesses sized and shaped to accept the resolution targets and aid positioning of the resolution targets on the interior surface of the retinal cup.

9. The model eye of claim 7, wherein the light contrasting region of different ones of the resolution targets includes different colors while the dark contrasting region is black.

10. The model eye of claim 1, further comprising:
a carrier substrate adhered to the interior surface of the retinal cup;
an array of light absorbing regions distributed across the carrier substrate; and
an array of color dots disposed on the array of light absorbing regions, the array of color dots having pre-characterized colors for testing color fidelity of the retinal imaging system, wherein the color dots are smaller than the light absorbing regions.

11. The model eye of claim 1, further comprising:
a plurality of resolution targets including the resolution target disposed on the interior surface of the retinal cup; and
platform regions formed into the interior surface, wherein each platform region has a different offset height with one of the resolution targets disposed thereon for assessing a depth of field (DOF) of the retinal imaging system.

12. The model eye of claim 11, wherein the platform regions are segmented into pie-shaped quadrants within the bowl-like shape of the interior surface.

13. The model eye of claim 1, wherein:
the model eye models a myopic eye by deforming the bowl-like shape representing the fundus into an elliptical shape disposed further back from a corneal plate of the model eye relative to an emmetropic eye position; or
the model eye models a hyperopic eye by shifting the bowl-like shape without deformation towards the corneal plate relative to the emmetropic eye position.

14. The model eye of claim 1, wherein the resolution target comprises a spatial frequency response registration (SFRreg) marker that is rotated such that the straight edges are oblique to tangential and sagittal planes of the retinal imaging systemwhen the model eye is positioned relative to the retinal imaging systemsimilar to how the human eye is positioned when imaging the human eye using the retinal imaging system.

15. The model eye of claim 1, further comprising:
a corneal plate;
an outer holder that holds the corneal plate over the retinal cup to define a fluid chamber representing a vitreous humor of the human eye; and
an encapsulate film deposited over the resolution target including the arrays of light and dark color microfeatures to seal the resolution target against the interior surface of the retinal cup and protect the resolution target from a liquid filled into the fluid chamber.

16. A model eye for evaluating a retinal imaging system, the model eye comprising:
a retinal cup including an interior surface having a bowl-like shape to represent a fundus of a human eye;
a plurality of resolution targets each disposed on the interior surface for assessing a spatial resolution of the retinal imaging system, the resolution targets each including light and dark contrasting regions with straight edges separating the light and dark contrasting regions; and
platform regions formed into the interior surface, wherein the platform regions have different offset heights with one of the resolution targets disposed on each of the platform regions for assessing a depth of field (DOF) of the retinal imaging system.

17. The model eye of claim 16, further comprising:
an array of dark color microfeatures disposed in the light contrasting region of at least one of the resolution targets, wherein the dark color microfeatures are variably sized for assessing the spatial resolution of the retinal imaging system; and
an array of light color microfeatures disposed in the dark contrasting region of the at least one of the resolution targets, wherein the light color microfeatures are variably sized for assessing the spatial resolution of the retinal imaging system.

18. The model eye of claim 16, wherein each of the resolution targets comprises an emulsion pattern disposed on a transparent flexible substrate and laminated with an adhesive backing that adheres the transparent flexible substrate to the interior surface of retinal cup, wherein the emulsion pattern forms the dark contrasting region.

19. The model eye of claim 18, wherein the adhesive backing comprises a colored vinyl adhesive layer that is masked by the emulsion pattern, wherein a color of the colored vinyl adhesive layer includes a shade of a color present on the fundus of the human eye.

20. The model eye of claim 16, wherein the platform regions are segmented into pie-shaped quadrants within the bowl-like shape of the interior surface.

21. The model eye of claim 16, wherein:
the model eye models a myopic eye by deforming the bowl-like shape representing the fundus into an elliptical shape disposed further back from a corneal plate of the model eye relative to an emmetropic eye position; or
the model eye models a hyperopic eye by shifting the bowl-like shape without deformation towards the corneal plate relative to the emmetropic eye position.
